(19) United States
(12) Patent Application Publication
(10) Pub. No.: US 2011/0086287 A1
(43) Pub. Date: Apr. 14, 2011

(54) SOLID OXIDE FUEL STACK

(75) Inventors: Ander Laresgoiti Rementeria, Iurreta (Bizkaia) (ES); Mireia Olave Irizar, Arrasate-Mondragon (Gipuzkoa) (ES); Jaio Manzanedo Gabilondo, Arrasate-Mondragon (Gipuzkoa) (ES)

(73) Assignee: IKERLAN, S.COOP., ARRASATE (GIPUZKOA) (ES)

(21) Appl. No.: 12/900,364

(22) Filed: Oct. 7, 2010

(30) Foreign Application Priority Data
Oct. 9, 2009 (ES) P200930826

(51) Int. Cl. H01M 8/24

(52) U.S. Cl. 429/466

(57) ABSTRACT

A solid oxide fuel stack. In one implementation a solid oxide fuel cell is supported by and electrically coupled to a connector with the solid oxide fuel cell having a first electrode, an electrolyte deposited on the first electrode, a second electrode deposited on the electrolyte, and a metal support arranged on the second electrode. In one implementation the connector has a first member in contact with a portion of the metal support and is arranged to resiliently support the first solid oxide fuel cell by the application of contact pressure to the portion of the metal support.

### CROSS-REFERENCE TO RELATED APPLICATIONS

This application claims priority to Spanish Patent Application No. P200930826, filed Oct. 9, 2009.

### TECHNICAL FIELD

This invention relates to solid oxide fuel stacks having at least one metal-supported tubular cell and at least one attached interconnector.

### BACKGROUND

There are known in the state of the art, solid oxide fuel stacks comprising a plurality of tubular solid oxide fuel cells, which operate at high temperatures within an approximate range of 600 to 1000° C., and which, depending on the type of support used, may be categorized as tube-shaped solid oxide fuel cells with a cathode support, anode support, electrolyte support or metal support.

Tubular solid oxide fuel cells generally comprise a structure formed by an internal electrode, an electrolyte deposited on the internal electrode, an external electrode deposited on the electrolyte, and in the case of metal-supported tubular cells, a metal support deposited mainly on the external electrode.

One of the problems to be resolved in this type of fuel stacks is the difficulty of forming an electrical connection between the respective cells, given that this type of cell operates at high temperatures, and the interconnectors must be designed in such a way that they are sufficiently flexible to maintain proper electrical contact, and must also withstand large thermal cycles. The interconnectors must also have an optimum contact surface to prevent a reduction in the power density of the cells.

There are known different solutions, described for example in International Appl. No. WO2006/017777A2, U.S. Pat. No. 5,258,240 and U.S. Pat. No. 7,157,172, which describe fuel stacks that comprise anode and/or cathode-supported tubular cells in which each tubular cell comprises a built-in interconnector that comes into contact with the internal electrode. The electrical connection between the built-in interconnector in a tubular cell and the external electrode of another adjacent tubular cell is formed by individual nickel interconnectors positioned between the adjacent cells or by mesh or metal supports positioned between the tubular cells.

### SUMMARY

According to one implementation a solid oxide fuel stack is provided comprising: a first solid oxide fuel cell supported by and electrically coupled to a first connector, the first solid oxide fuel cell comprising a first electrode, an electrolyte deposited on the first electrode, a second electrode deposited on the electrolyte, and a first metal support arranged on the second electrode, the first connector having a first member in contact with a first portion of the first metal support, the first connector arranged to resiliently support the first solid oxide fuel cell by the application of contact pressure to the first portion of the first metal support.

According to one implementation a solid oxide fuel stack is provided comprising: first a solid oxide fuel cell supported between and electrically coupled to first and second connectors, the solid oxide fuel cell comprising a first electrode, an electrolyte deposited on the first electrode, a second electrode deposited on the electrolyte, and a first metal support arranged on the second electrode, the first connector having a first member in contact with a first portion of the first metal support and a second member in contact with a second portion of the first metal support, the second connector having a first member in contact with a third portion of the first metal support and a second member in contact with a fourth portion of the first metal support, the first and second connectors each arranged to resiliently support the first solid oxide fuel cell by the application of contact pressure to the first, second, third and fourth portions of the first metal support.

According to one implementation a solid oxide fuel stack is provided comprising: a solid oxide fuel cell supported between and electrically coupled to a first plate and a second plate by first and second connectors, respectively, the solid oxide fuel cell comprising a first electrode, an electrolyte deposited on the first electrode, a second electrode deposited on the electrolyte, and a metal support arranged on the second electrode, the first connector having a first member in contact with a first portion of the metal support and a second member in contact with a second portion of the metal support, the second connector having a first member in contact with a third portion of the metal support and a second member in contact with a fourth portion of the tubular support, the first and second connectors fixed to the first and second support plates, respectively, and each arranged to resiliently support the solid oxide fuel cell between the first and second support plates by the application of contact pressure to the first, second, third and fourth portions of the metal support.

According to one implementation a tubular solid oxide fuel cell is provided that comprises a first electrode, an electrolyte deposited on the first electrode, a second electrode deposited on the electrolyte, and a metal support arranged on the second electrode. In one implementation the interconnector comprises support means and contact means adapted for the electrical contact with the metal support, the contact means being arranged fixed to the support means and flexible in relation to said support means. The interconnector is also arranged preloaded in relation to the metal support, with the result that the contact pressure between the interconnector and the metal support is obtained by means of the preload, ensuring said contact even at high temperatures for long periods of time.

The flexibility of the contact means as opposed to the support means allows the interconnector to remain in contact with the metal support at all times regardless of the irregularities in shape that the tubular solid oxide fuel cell may present both longitudinally and transversally.

In addition, the interconnector has a compact and simple design that enables the fitting of the solid oxide fuel cell.

These and other advantages and characteristics of the invention will be made evident in the light of the drawings and the detailed description thereof.

### DESCRIPTION OF THE DRAWINGS

FIG. 1 is a front view of a first embodiment of a solid oxide fuel stack.

FIG. 2 is a view in perspective of the solid oxide fuel stack shown in FIG. 1.

FIG. 3 is a front view of a second embodiment of a solid oxide fuel stack.

FIG. 4 is a front view of a third embodiment of a solid oxide fuel stack.

FIG. 5 is a front view of a fourth embodiment of a solid oxide fuel stack.

FIG. 6 is a front view of a fifth embodiment of a solid oxide fuel stack.

FIG. 7 is a view in perspective of the solid oxide fuel stack shown in FIG. 6.

### DETAILED DESCRIPTION

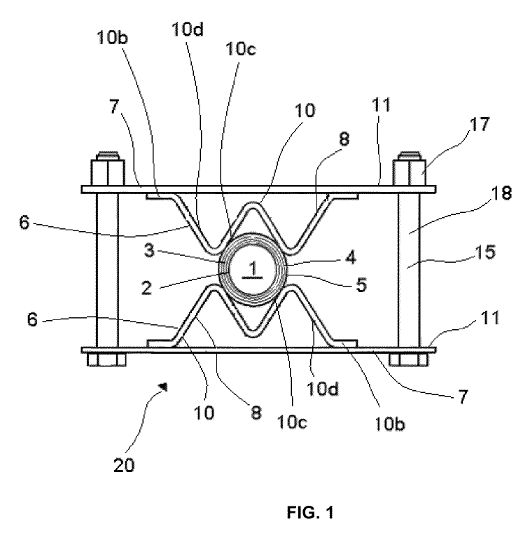

FIGS. 1 to 7 illustrate implementations of a solid oxide fuel stack 20 having at least one tubular solid oxide fuel cell 1 and interconnectors 6 associated to the solid oxide fuel cell 1.

Each tubular solid oxide fuel cell 1, shown in detail in FIG. 1, comprises a first electrode 2, an electrolyte 3 deposited on the first electrode 2, a second electrode 4 deposited on the electrolyte 3, and a metal support 5 arranged fixed on the second electrode 4. The first electrode 2 is the anode and the second electrode 4 is the cathode, the materials of the first electrode 2, the second electrode 4 and the electrolyte 3 being known in the prior art.

In the implementations of FIGS. 1 to 7 each solid oxide fuel cell 1 is associated to two interconnectors 6 arranged substantially parallel to, and facing each other.

In one implementation, each interconnector 6 comprises support means 7, which may include a substantially rectangular and rigid support plate 11, and contact means 8 through which the electrical contact of the interconnector 6 with the metal support 5 of the solid oxide fuel cell 1 is achieved. The contact means 8 is arranged fixed to the support plate 11 by welding or any other known means, and are flexible in relation to said support plate 11.

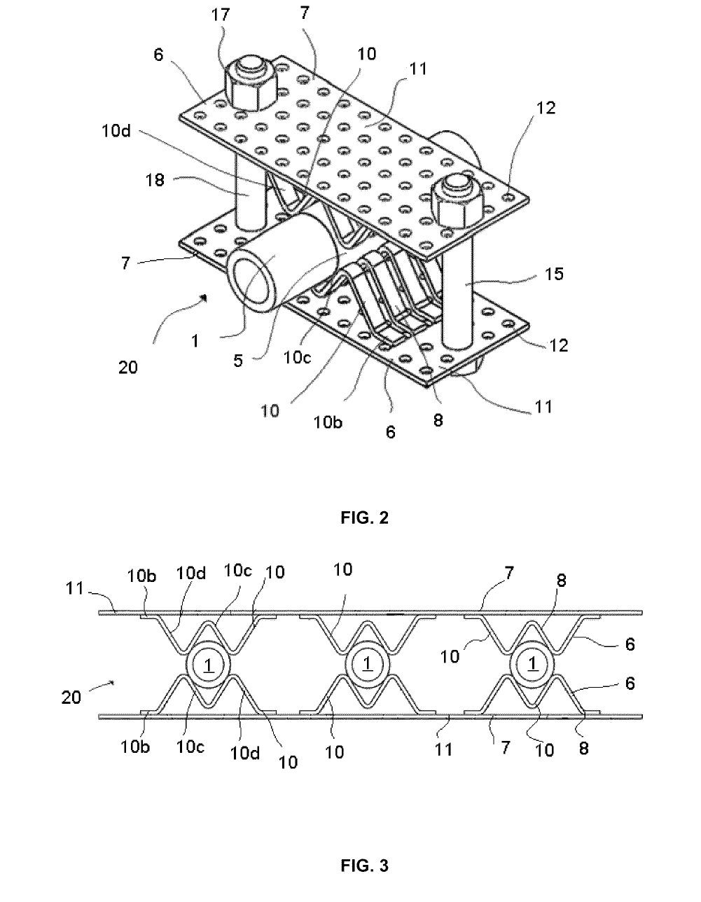

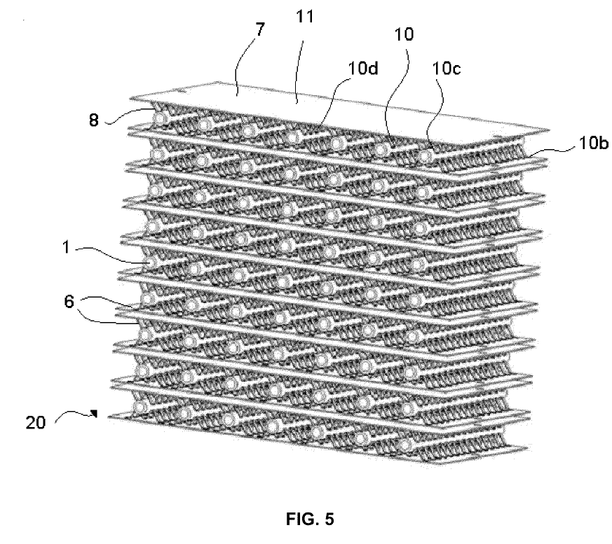

In some implementations the support plate 11 has a thickness of between approximately 0.5 and 1.0 mm, and may include, as shown in FIGS. 2 and 5, holes 12 arranged along the support plate 11 with the object of improving the circulation of air towards the fuel cell 1. In some implementations the holes 12 are arranged equidistantly along the support plate 11

In the implementations of FIGS. 1 to 7 the support plates 11 and therefore the interconnectors 6 are arranged substantially horizontally. In other examples, not shown in the figures, said support plates 11 may be positioned substantially vertically.

In addition, the corresponding interconnector 6 is arranged preloaded in relation to the metal support 5 with the aim of ensuring proper electrical contact at all times with the tubular fuel cell 1. To achieve this, in one implementation the solid oxide fuel stack 20 comprises preload means 15, shown in FIGS. 1 and 2. In one implementation the preload means 15 comprise screws 18, each one of which pass through the support plates 11 arranged facing each other, and nuts 17 through which the screws 18 are fixed to the corresponding support plates 11, the interconnectors 6 maintaining a prefixed pressure against the solid oxide fuel cell 1 as a result of the preload applied by the screws 18 and nuts 17.

In other embodiments not shown in the figures, the preload means 15 may include an external weight on at least one of the support plates 11 or preloaded springs arranged between the two support plates 11 of two interconnectors 6 facing each other, thereby ensuring the permanent contact between the corresponding interconnector 6 and the solid oxide fuel cell 1.

In addition, the contact means 8 comprise a contact plate 10,16 that includes at least one substantially flat fixing surface 10b,16b, through which the contact plate 10,16 is fixed to the support plate 11, and at least one contact surface 10c,16c flexible in relation to the fixing surface 10b,16b, adapting itself to the possible irregularities in shape that the tubular fuel cell 1 may present, either on its circular perimeter or longitudinally, thereby securing the permanent electrical contact of the interconnector 6 with the tubular fuel cell 1. In one implementation the contact means 8 also comprises connection surfaces 10d,16d that respectively connect each contact surface 10c,16c to the corresponding fixing surface 10b,16b.

According to some implementations each interconnector 6 comprises a plurality of contact plates 10,16 that have a thickness of between approximately 0.5 mm and 1 mm, and are arranged transversally along the metal support 5 and substantially parallel and equidistant to each other.

In the embodiments shown in FIGS. 1 to 5, the contact plate 10 is substantially W-shaped. In one implementation the contact plate 10 includes two substantially straight contact surfaces 10c, continuous and inclined to each other, a fixing surface 10b on each end of the contact plate 10, through which is fixed said contact plate 10 to the support plate 11, and the connection surfaces 10d that respectively connect each contact surface 10c to the corresponding fixing surface 10b.

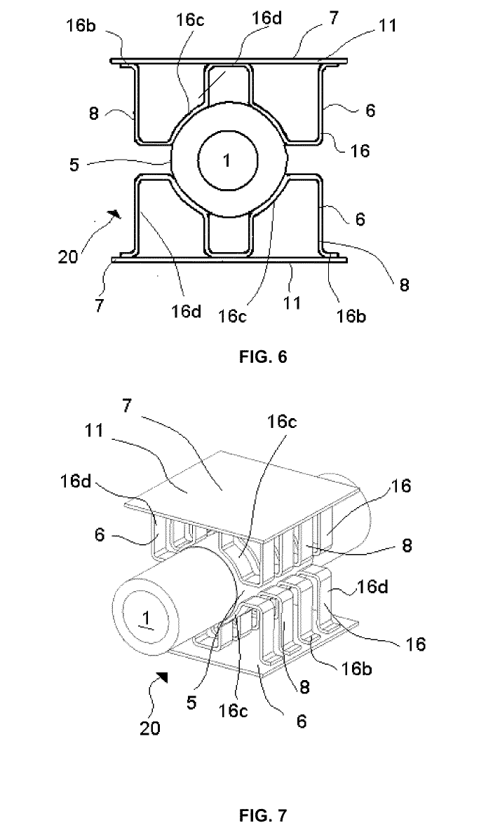

Additionally, in the embodiment shown in FIGS. 6 and 7, the contact plate 16 includes two substantially curved contact surfaces 16c adapted to the outer shape of the tubular fuel cell 1, and the connection surfaces 16d connecting the ends of the contact surfaces 16c to the corresponding fixing surfaces 16b. In other embodiments not shown in the figures, the contact surfaces 16c may be arranged substantially projecting outwards, being connected to the corresponding connection surface 16b only through one of its ends.

FIGS. 1, 2, 6 and 7 show a solid oxide fuel stack 20 comprising a single tubular fuel cell 1.

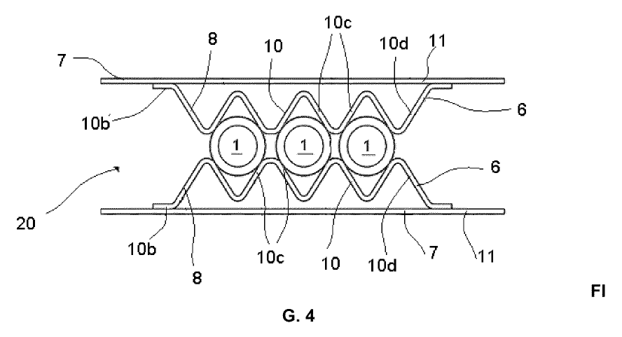

FIGS. 3 to 5 show a solid oxide fuel stack 20 comprising at least one row of tubular fuel cells 1, said fuel cells 1 being arranged substantially parallel and adjacent to each other, the preload means not being shown in the figures.

FIG. 3 shows an embodiment in which the support plates 11 of the interconnectors 6 arranged adjacent to each other, associated to fuel cells 1 arranged adjacently, form a single support plate 11, the respective contact plates 10 being fixed to said single support plate 11.

In addition, FIG. 4 shows an embodiment in which the contact plates 10 of the interconnectors 6 arranged adjacent to each other, associated to adjacent fuel cells 1, form a single contact plate 10 that has contact surfaces 10c of each individual contact plate 10 connected to each other. Additionally, as in the preceding embodiment, the support plates 11 of the adjacent interconnectors 6 attached to adjacent fuel cells 1 form a single support plate 11.

FIG. 5 shows a solid oxide fuel stack 20 embodiment comprising various rows of tubular cells 1 arranged adjacent and parallel to each other, wherein the interconnectors 6 corresponding to each row of tubular cells 1 are similar to the ones shown in FIG. 4.

In other embodiments not shown in the figures, the contact plate 10,16 may have a single contact surface 10c,16c with the tubular fuel cell 1, said single contact surface 10c,16c being flexible in relation to the connection surface 10b,16b and therefore to the corresponding support plate 11.

According to some implementations, both the support plate 11 and the contact plate 10,16 are preferably made of a metal material capable of withstanding high temperatures, in excess of 800° C., for long periods of time. The oxidation behaviour of the material must be good at high temperatures, it must be able to resist creep when subjected to a constant force, and must also be easily conformable.

What is claimed is:

1. A solid oxide fuel stack comprising: a first solid oxide fuel cell supported by and electrically coupled to a first connector, the first solid oxide fuel cell comprising a first electrode, an electrolyte deposited on the first electrode, a second electrode deposited on the electrolyte, and a first metal support arranged on the second electrode, the first connector having a first member in contact with a first portion of the first metal support, the first connector arranged to resiliently support the first solid oxide fuel cell by the application of contact pressure to the first portion of the first metal support.

2. A solid oxide fuel stack according to claim 1, wherein the first connector comprises a second member in contact with a second portion of the first metal support, the first connector arranged to resiliently support the solid oxide fuel cell by the application of contact pressure to the first and second portions of the first metal support.

3. A solid oxide fuel stack according to claim 1, wherein the first connector is fixed to a support plate.

4. A solid oxide fuel stack according to claim 2, wherein the first connector is fixed to a support plate.

5. A solid oxide fuel stack according to claim 1, wherein the support plate comprises air passage apertures.

6. A solid oxide fuel stack according to claim 2, wherein the first and second members are inclined to each other.

7. A solid oxide fuel stack according to claim 2, wherein the first connector has a substantially W-shaped cross-section.

8. A solid oxide fuel stack according to claim 1, wherein the first metal support is tubular, the first member having a first substantially curved surface in contact with the first portion of the metal support.

9. A solid oxide fuel stack according to claim 2, wherein the first metal support is tubular, the first member having a first substantially curved surface in contact with the first portion of the first metal support and the second member having a second substantially curved surface in contact with the second portion of the first metal support.

10. A solid oxide fuel stack according to claim 1, further comprising a second solid oxide fuel cell spaced from and adjacent to the first solid oxide fuel cell, the second solid oxide fuel cell comprising a first electrode, an electrolyte deposited on the first electrode, a second electrode deposited on the electrolyte, and a second metal support arranged on the second electrode, the first connector having a second member in contact with a first portion of the second metal support, the first connector arranged to resiliently support the first and second solid oxide fuel cells by the application of contact pressure to the first portions of the first and second metal supports.

11. A solid oxide fuel stack according to claim 1, further comprising a second solid oxide fuel cell spaced from and adjacent to the first solid oxide fuel cell, the second solid oxide fuel cell supported by and electrically coupled to a second connector, the second solid oxide fuel cell comprising a first electrode, an electrolyte deposited on the first electrode, a second electrode deposited on the electrolyte, and a second metal support arranged on the second electrode, the second connector having a first member in contact with a first portion of the second metal support, the second connector arranged to resiliently support the second solid oxide fuel cell by the application of contact pressure to the first portion of the second metal support.

12. A solid oxide fuel stack according to claim 10, wherein the first connector is fixed to a support plate.

13. A solid oxide fuel stack according to claim 10, wherein the first and second connectors are fixed to a support plate.

14. A solid oxide fuel stack comprising: a first solid oxide fuel cell supported between and electrically coupled to first and second connectors, the solid oxide fuel cell comprising a first electrode, an electrolyte deposited on the first electrode, a second electrode deposited on the electrolyte, and a first metal support arranged on the second electrode, the first connector having a first member in contact with a first portion of the first metal support and a second member in contact with a second portion of the first metal support, the second connector having a first member in contact with a third portion of the first metal support and a second member in contact with a fourth portion of the first metal support, the first and second connectors each arranged to resiliently support the first solid oxide fuel cell by the application of contact pressure to the first, second, third and fourth portions of the first metal support.

15. A solid oxide fuel stack according to claim 14, wherein the first connector is fixed to a first support plate and the second connector is fixed to a second support plate.

16. A solid oxide fuel stack according to claim 15, wherein the first and second support plates are arranged substantially parallel to one another.

17. A solid oxide fuel stack according to claim 15, wherein the first and second support plates comprise air passage apertures.

18. A solid oxide fuel stack according to claim 14, wherein the first and second members of each of the first and second connectors are inclined to each other.

19. A solid oxide fuel stack according to claim 14, wherein the first connector has a substantially W-shaped cross-section.

20. A solid oxide fuel stack according to claim 14, wherein the second connector has a substantially W-shaped cross-section.

21. A solid oxide fuel stack according to claim 14, wherein each of the first and second connectors has a substantially W-shaped cross-section.

22. A solid oxide fuel stack according to claim 14, wherein the first metal support is tubular, the first member and second member of each of the first and second connectors having contact surfaces that substantially conform to the first, second, third and fourth portions of the metal support.

23. A solid oxide fuel stack according to claim 14, further comprising a second solid oxide fuel cell spaced from and adjacent to the first solid oxide fuel cell, the second solid oxide fuel cell comprising a first electrode, an electrolyte deposited on the first electrode, a second electrode deposited on the electrolyte, and a second metal support arranged on the second electrode, the first connector having a third member in contact with a first portion of the second metal support and a fourth member in contact with a second portion of the second metal support, the second connector having a third member in contact with a third portion of the second metal support and a fourth member in contact with a fourth portion of the second metal support, the first and second connectors arranged to resiliently support the first and second solid oxide fuel cells by the application of contact pressure to the first, second, third and fourth portions of the first and second metal supports, respectively.

24. A solid oxide fuel stack according to claim 23, wherein the first connector is fixed to a first support plate and the second connector is fixed to a second support plate.

25. A solid oxide fuel stack according to claim 15, wherein the first and second support plates are connected together by a nut and bolt arrangement, the nut and bolt moveable relative to one another to enable the contact pressure applied to the first, second, third and fourth portions of the first metal support to be adjusted.

26. A solid oxide fuel stack according to claim 24, wherein the first and second support plates are connected together by a nut and bolt arrangement, the nut and bolt moveable relative to one another to enable the contact pressure applied to the first, second, third and fourth portions of the first and second metal supports to be adjusted.

27. A solid oxide fuel stack comprising: a solid oxide fuel cell supported between and electrically coupled to a first plate and a second plate by first and second connectors, respectively, the solid oxide fuel cell comprising a first electrode, an electrolyte deposited on the first electrode, a second electrode deposited on the electrolyte, and a metal support arranged on the second electrode, the first connector having a first member in contact with a first portion of the metal support and a second member in contact with a second portion of the metal support, the second connector having a first member in contact with a third portion of the metal support and a second member in contact with a fourth portion of the tubular support, the first and second connectors fixed to the first and second support plates, respectively, and each arranged to resiliently support the solid oxide fuel cell between the first and second support plates by the application of contact pressure to the first, second, third and fourth portions of the metal support.

28. A solid oxide fuel stack according to claim 27, wherein the first and second support plates are arranged substantially parallel to one another.

29. A solid oxide fuel stack according to claim 27, wherein the first and second support plates comprise air passage apertures.

30. A solid oxide fuel stack according to claim 27, wherein the first and second members of each of the first and second connectors are inclined to each other.

31. A solid oxide fuel stack according to claim 27, wherein the first connector has a substantially W-shaped cross-section.

32. A solid oxide fuel stack according to claim 27, wherein the second connector has a substantially W-shaped cross-section.

33. A solid oxide fuel stack according to claim 27, wherein each of the first and second connectors has a substantially W-shaped cross-section.

34. A solid oxide fuel stack according to claim 27, wherein the first metal support is tubular, the first member and second member of each of the first and second connectors having contact surfaces that substantially conform to the first, second, third and fourth portions of the metal support.

35. A solid oxide fuel stack according to claim 28, wherein the first and second support plates are connected together by a nut and bolt arrangement, the nut and bolt moveable relative to one another to enable the contact pressure applied to the first, second, third and fourth portions of the first metal support to be adjusted.
